(19) United States
(12) Patent Application Publication
(10) Pub. No.: US 2003/0052892 A1
(43) Pub. Date: Mar. 20, 2003

(54) Method for coloring handwriting locus of handwriting input device

(76) Inventors: Chi-Ti Kao, Yung-Ho City (TW); Cheng-Tang Su, Hsinchu City (TW)

Correspondence Address: SUPREME PATENT SERVICES, POST OFFICE BOX 2339, SARATOGA, CA, 95070, US

(21) Appl. No.: 09/954,845

(22) Filed: Sep. 17, 2001

(51) Int. Cl. G09G 5/02

(52) U.S. Cl. 345/589

(57) ABSTRACT

A method for coloring handwriting locus of handwriting input device comprises: (a) Setting the values of the three original colors (red-green-blue, RGB) at the starting point of a handwriting locus as a set of reference values; (b) Choosing the value of one of the original colors as a variable, which is decreased or increased by degrees to thereby obtain a plurality of RGB combinations to be taken as the RGB values of the ensuing locus points until the variable is decreased down to 0 or increased up to 255, and resetting the RGB values of the last combination as a restart set of reference values; (c) Judging whether the locus input action is ceased or not; if “true”, the step is quitted to exit, or continue to the next step if “false; and (d) Choosing the value of another original color as a variable and repeating step (b), except the variable is decreased or increased by degrees in directions reverse to that in step (b), then returning to step (c).

### FIELD OF THE INVENTION

This invention relates generally to handwriting input devices, particularly to a handwriting input device that can enrich the color of an induced handwriting locus.

### BACKGROUND OF THE INVENTION

In the booming era of the multimedia products, the appeal in richness, entertainingness, and vividness of picture are considered the major inducements to attract people or players to indulge in playing computer games day and night.

However, most of the available multimedia products until now, particularly the handwriting input devices, are monochromatic in locus and failed to meet people' requirements as mentioned above.

### SUMMARY OF THE INVENTION

The primary object of this invention is to eliminate the monochromatic defect of the prior handwriting input device to enrich the handwriting locus with vivid colors.

In order to realize abovesaid object, a method for coloring handwriting locus of handwriting input device comprises the following steps:

(a) Setting the values of the three original colors (red-green-blue, RGB) at the starting point of a handwriting locus as a set of reference values;

(b) Choosing the value of one of the original colors as a variable, which is decreased or increased by degrees to thereby obtain a plurality of RGB combinations to be taken as the RGB values of the ensuing locus points until the variable is decreased down to 0 or increased up to 255, and resetting the RGB values of the last combination as a restart set of reference values;

(c) Judging whether the locus input action is ceased or not; if “true”, the step is quitted to exit, or continue to the next step if “false; and

(d) Choosing the value of another original color as a variable to be changed by way like step (b), except the variable is decreased or increased by degrees in directions reverse to that in step (b) so as to obtain a plurality of RGB combinations, which is then taken as the RGB values of the ensuing locus points and so repeated until the variable is decreased down to 0 or increased up to 255 to have the last combination of RGB values reset as a restart set of reference values and returning to step (c).

For more detailed information regarding advantages or features of this invention, at least an example of preferred embodiment will be elucidated below with reference to the annexed drawings.

### BRIEF DESCRIPTION OF THE DRAWINGS

The related drawings in connection with the detailed description of this invention to be made later are described briefly as follows, in which:

FIG. 1 shows a flowchart of this invention;

FIG. 2 shows a cross-reference table of RGB values of handwriting locus points basing on a method of this invention; and

FIG. 3 shows a substantial embodiment of this invention.

### DETAILED DESCRIPTION OF THE INVENTION

This invention is mainly highlighted in providing a method for enrichment of a handwriting locus with brilliant colors.

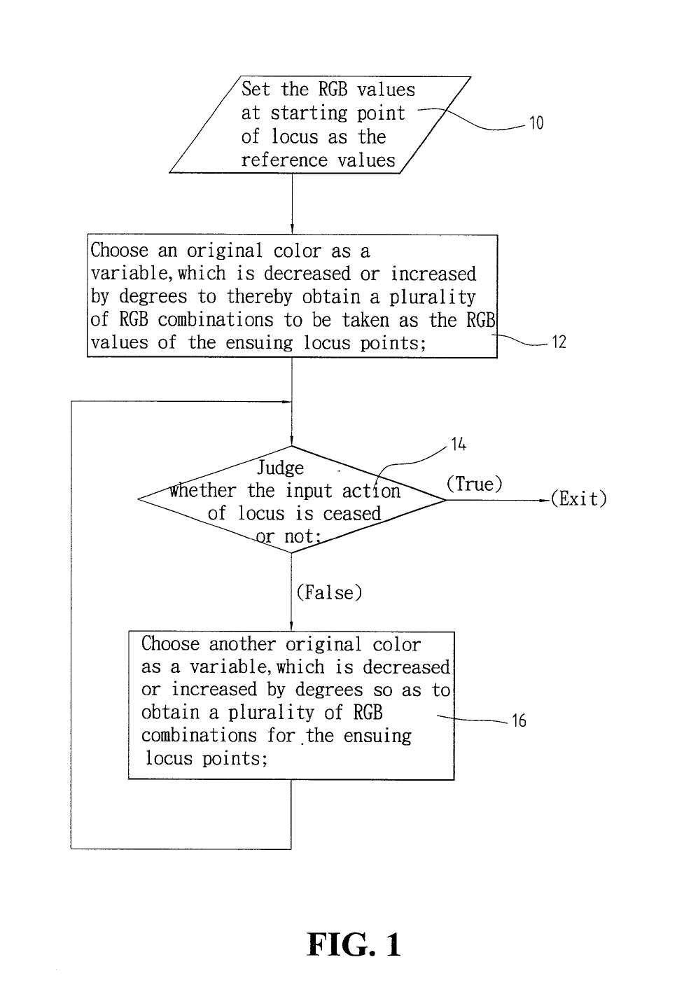

As indicated in a flowchart of this invention shown in FIG. 1, the method comprises: step 10 for setting values of the three original colors (red-green-blue, RGB) at a starting point of locus as the reference values; step 12 for choosing an original color as a variable, which is decreased or increased by degrees to thereby obtain a plurality of RGB combinations, which is then taken as the RGB values of the ensuing locus points and so repeated until the variable is decreased down to 0 or increased up to 255 to have the last combination of the RGB values reset as a restart set of reference values; step 14 for judging whether the input action of locus is ceased or not, if “true”, the step is quitted to exit, or continue to the next step if “false”; step 16 for choosing another original color as a variable basing on step 12, wherein the variable is decreased or increased by degrees in directions reverse to that in step 12 so as to obtain a plurality of RGB combinations, which is then taken as the RGB values of the ensuing locus points and so repeated until the variable is decreased down to 0 or increased up to 255 to have the last combination of RGB values reset as a restart set of reference values.

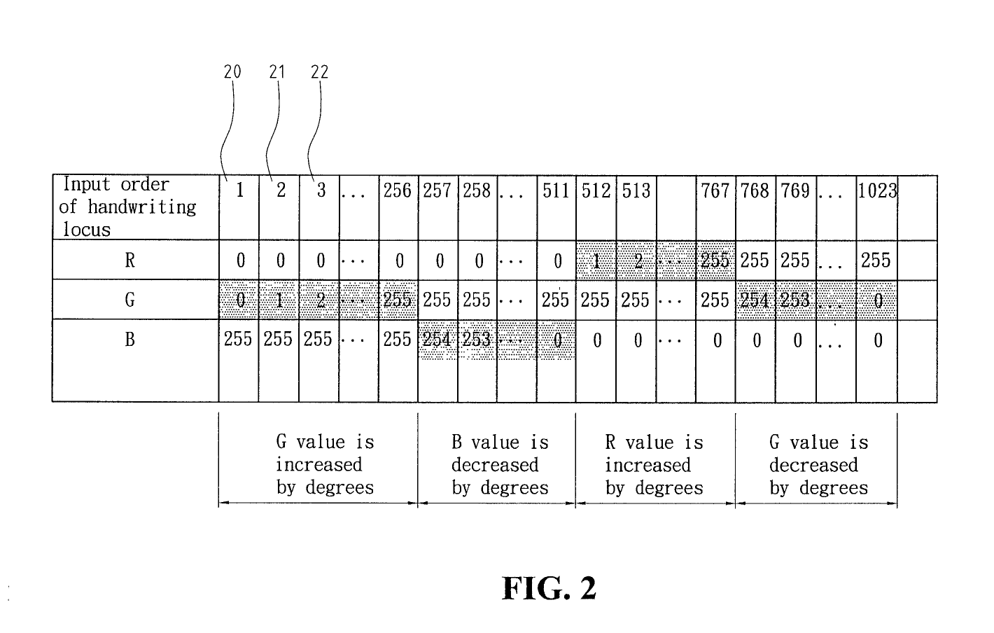

FIG. 2 shows a cross-reference table of RGB values of handwriting locus points basing on a method of this invention. According to this table, the RGB values set at a locus starting point 20 are R(red)-0, G(green)-0, B(blue)-255 respectively, wherein the value of original green G is increased by degrees. The RGB values set at a second locus point 21 are R-0, G-1, B-255, then R-0, G-2, B-255 at a third locus point 22, and so forth until R-0, G-255, B-255. Setting the RGB values in this manner can provide a soft and smooth color change. Following to the forgoing process, the value of original blue B starts now to be decreased by degrees, in turn the value of original red R starts to be increased by degrees, then the process goes back to decrease the value of original green G by degrees. The cyclic conversion among different colors staggeringly in slight change by degrees alternately will avoid any conspicuous difference in color.

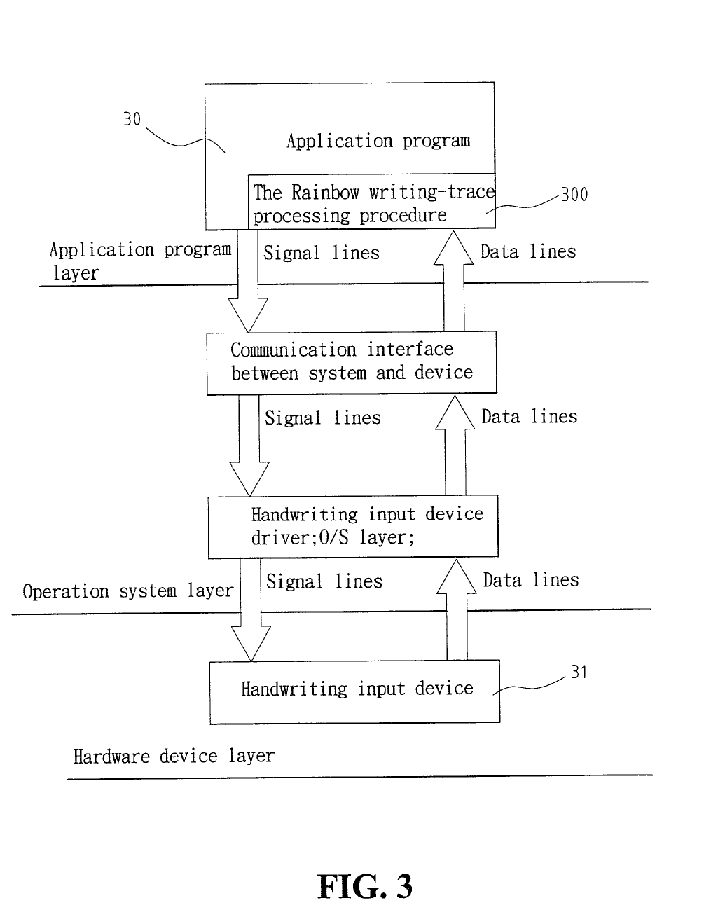

As illustrated in an embodiment of handwriting input device shown in FIG. 3, an application program 30 in the application program layer, such as the software of: graphics, word processor, or handwriting recognition, comprises a rainbow writing-trace processing procedure 300, which is a subprogram programmed with a programming language for realizing the method of this invention. The application program 30 will call the rainbow writing-trace processing procedure 300 for setting the RGB values of the input locus points sequentially made by a handwriting input device 31, then returning the same to the application program 30 for display of the colored handwriting locus on a monitor.

In the above described, at least one preferred embodiment has been described in detail with reference to the drawings annexed, and it is apparent that numerous variations or modifications may be made without departing from the true spirit and scope thereof, as set forth in the claims below.

What is claimed is:

1. A method for coloring handwriting locus of handwriting input device, comprising:
(a) setting the values of the three original colors (red-green-blue, RGB) at the starting point of a handwriting locus as a set of reference values;
(b) choosing the value of one of the original colors as a variable, which is decreased or increased by degrees to thereby obtain a plurality of RGB combinations to be taken as the RGB values of the ensuing locus points until the variable is decreased down to 0 or increased up to 255, and resetting the RGB values of the last combination as a restart set of reference values;
(c) judging whether the locus input action is ceased or not; if “true”, the step is quitted to exit, or continue to the next step if “false; and
(d) choosing the value of another original color as a variable to be changed by way like step (b), except the variable is decreased or increased by degrees in directions reverse to that in step (b) so as to obtain a plurality of RGB combinations, which is then taken as the RGB values of the ensuing locus points and so repeated until the variable is decreased down to 0 or increased up to 255 to have the last combination of RGB values reset as a restart set of reference values and returning to the step for judging whether the locus input action is ceased or not.

2. The method according to claim 1, further comprising the step of programming the step (a) through the step (d) into an executable program.

3. A computer readable storage media, comprising at least an executable program programmed according to the method of claim 1.
